(19) United States
(12) Patent Application Publication
(10) Pub. No.: US 2026/0147123 A1
(43) Pub. Date: May 28, 2026

(54) RADIO FREQUENCY (RF) INTERFERENCE HANDLING FOR POSITIONING

(71) Applicant: QUALCOMM Incorporated, San Diego, CA (US)

(72) Inventor: Avinash SHRIVASTAVA, Hyderabad (IN)

(21) Appl. No.: 18/962,074

(22) Filed: Nov. 27, 2024

(51) Int. Cl. G01S 19/21; G01S 19/05

(52) U.S. Cl. CPC G01S 19/21; G01S 19/05

(57) ABSTRACT

Techniques are disclosed in which a location server can support positioning of a user equipment (UE) by receiving a capability of the UE for performing a positioning operation and a status of the UE for receiving radio frequency (RF) signals via a global navigation satellite system (GNSS) band. The location server can determine the UE communicates with the wireless network via a first non-terrestrial-network (NTN) node of a wireless network using a first communication frequency band that overlaps in frequency with the GNSS band, and send positioning assistance data to the UE for performing the positioning operation. The positioning assistance data may indicate to the UE to perform the positioning operation without using the GNSS band, communicate with the wireless network via a terrestrial node (TN) or a second NTN node of the wireless network during the positioning operation, using a second communication frequency band, or any combination thereof.

### BACKGROUND

### 1. Field of Disclosure

The present disclosure generally relates to the field of mobile device positioning using radio frequency (RF) signals and, more specifically, to global navigation satellite system (GNSS)-based positioning in conjunction with Non-Terrestrial Network (NTN)-based wireless communications.

### 2. Description of Related Art

RF-based positioning performed by wireless electronic devices, especially when used in a mobile communication (cellular) network, can provide significant added value to users. Mobile phones and vehicles, for example, can use such positioning to provide location-based services, such as maps and navigation. Further, determining the position of a mobile phone or vehicle can help emergency services quickly locate people in need. Such RF-based positioning may use RF signals from global navigation satellite system (GNSS) satellites and/or wireless nodes of the mobile communication network.

### BRIEF SUMMARY

An example method at a location server of a wireless network for supporting positioning of a user equipment (UE), according to this disclosure, comprises receiving a capability message from the UE comprising information regarding a capability of the UE for performing a positioning operation. The capability message may include an indication of a status of the UE for receiving radio frequency (RF) signals via a first global navigation satellite system (GNSS) band. The method further comprises determining the UE communicates with the wireless network via a first non-terrestrial-network (NTN) node of the wireless network using a first communication frequency band that overlaps in frequency, at least in part, with the first GNSS band. The method further comprises sending positioning assistance data to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

An example location server, according to this disclosure, comprises one or more transceivers, one or more memories, and one or more processors communicatively coupled with the one or more transceivers and the one or more memories. The one or more processors are configured to receive a capability message, via the one or more transceivers, from a user equipment (UE) comprising information regarding a capability of the UE for performing a positioning operation, wherein the capability message includes an indication of a status of the UE for receiving radio frequency (RF) signals via a first global navigation satellite system (GNSS) band. The one or more processors are further configured to determine the UE communicates with a wireless network via a first non-terrestrial-network (NTN) node of the wireless network using a first communication frequency band that overlaps in frequency, at least in part, with the first GNSS band. The one or more processors are configured to send positioning assistance data, via the one or more transceivers, to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

An example device, according to this disclosure, comprises means for receiving a capability message from a user equipment (UE) comprising information regarding a capability of the UE for performing a positioning operation, wherein the capability message includes an indication of a status of the UE for receiving radio frequency (RF) signals via a first global navigation satellite system (GNSS) band. The device further comprises means for determining the UE communicates with a wireless network via a first non-terrestrial-network (NTN) node of the wireless network using a first communication frequency band that overlaps in frequency, at least in part, with the first GNSS band. The device further comprises means for sending positioning assistance data to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a positioning system, according to an embodiment.

FIG. 2 is an illustration of a fifth-generation (5G) new radio (NR) positioning system, according to an embodiment.

FIG. 3 is an illustration of aspects of a non-terrestrial network (NTN) system, according to an embodiment.

FIG. 4 is a diagram of global navigation satellite system (GNSS) frequency bands.

FIG. 5 is a message flow diagram of how a location server and user equipment (UE) may exchange information, according to an embodiment.

FIG. 6 is an illustration of an example scenario in which interference management may be used.

FIG. 7 is a flow diagram of a method for supporting the positioning of a UE, according to some embodiments.

FIG. 8 is a block diagram of an embodiment of a UE.

FIG. 9 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Further, unless otherwise specified, the terms “positioning,” “position determination,” “location determination,” “location estimation,” and the like, as used herein, may include absolute location determination, relative location determination, ranging, or a combination thereof. Such positioning may include and/or be based on timing, angular, phase, or power measurements, or a combination thereof (which may include RF sensing measurements) for the purpose of location or sensing services.

As noted, RF-based positioning (also referred to herein simply as “RF positioning”) may be performed by wireless electronic devices (electronic devices capable of transmitting and/or receiving RF signals, also referred to herein as “wireless devices”), and can have a wide range of consumer, industrial, commercial, and other applications. The performance of RF positioning operations may involve one or more wireless devices, and these operations may be coordinated and/or facilitated by a wireless network. In a wireless communication network (e.g., a cellular network), wireless devices may be referred to as user equipments, or UEs. To access the wireless communication network, these UEs may communicate with wireless nodes, or base stations. Typically, these nodes are terrestrial. However, wireless communication networks are increasingly using non-terrestrial nodes (otherwise referred to herein as non-terrestrial network (NTN) nodes), such as satellites, to increase wireless communication network coverage.

Problems may arise at a UE, however, when using NTN nodes and global navigation satellite system (GNSS) positioning concurrently. Specifically, one NTN frequency band commonly used in NTN nodes, NTN n255, overlaps with a commonly used GNSS band: the GNSS L1 frequency band (which, as indicated elsewhere herein, includes the L1 band in the Global Positioning System (GPS) and bands in other GNSS systems). Thus, a UE that communicates with an NTN node using the interfering n255 band may cause an outage in the GNSS L1 band for that UE, which can frustrate attempts at performing positioning of the UE. Further, there are currently no effective means by which a wireless communication network coordinates communication and positioning to avoid such interference.

Embodiments described herein address these and other issues by enabling accommodations in communication and/or positioning to help avoid such interference. According to some embodiments, this can include deactivating or turning off GNSS L1 band at the UE, switching to another band for communications between the UE and an NTN node, using alternative GNSS bands for positioning the UE, using non-GNSS positioning solutions, or the like. In some examples, a location server can gather information regarding the rough location of a UE and available communication coverage options and provide the UE with instructions for performing a positioning operation in a manner that mitigates or avoids interference between the GNSS L1 band and NTN node communications. According to some embodiments, the location server can gather information and maintain a database that enables a location to determine available communication coverage options. Additionally, or alternatively, according to some embodiments, information communicated to and/or from a location server can be conveyed using existing protocols (or modifications thereof), such as Long-Term Evolution (LTE) Positioning Protocol (LPP) and/or New Radio Positioning Protocol A (NRPPa). In some examples, a UE may provide capability information to the location server to help the location server determine a particular interference management technique. It can be noted that, although embodiments herein discuss interference between GNSS L1 and NTN n255 frequency bands, embodiments are not so limited and may be extended to other cases in which GNSS and NTN frequency bands may similarly interfere.

Particular aspects of the subject matter described in this disclosure can be implemented to realize one or more of the following potential advantages. In some examples, by providing a formalized means by which interference between NTN communications and GNSS positioning may be avoided, embodiments may enable reliable positioning of a GNSS-enabled UE in the presence of NTN communications. Further, by providing relevant capability information from the UE to a location server and/or by allowing a location server to gather and maintain NTN-related coverage information, embodiments can allow for a location server to provide customized, efficient interference management techniques that the UE can perform to ensure effective positioning and continued communication coverage. These and other advantages will be apparent to persons of ordinary skill in light of the disclosed embodiments detailed hereafter. A discussion of embodiments is provided after a brief discussion of relevant technology and context/background in which embodiments may be used.

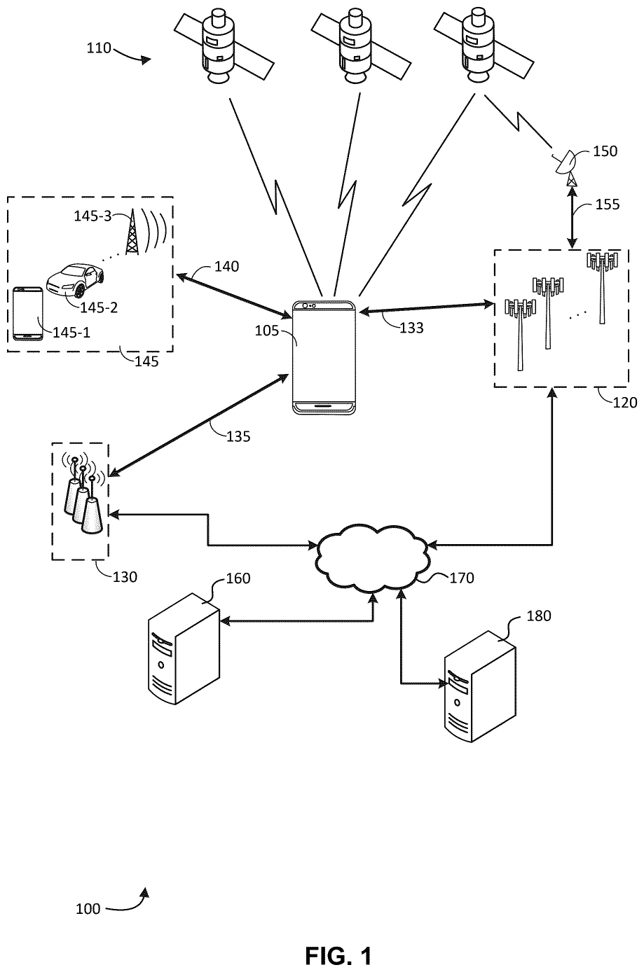

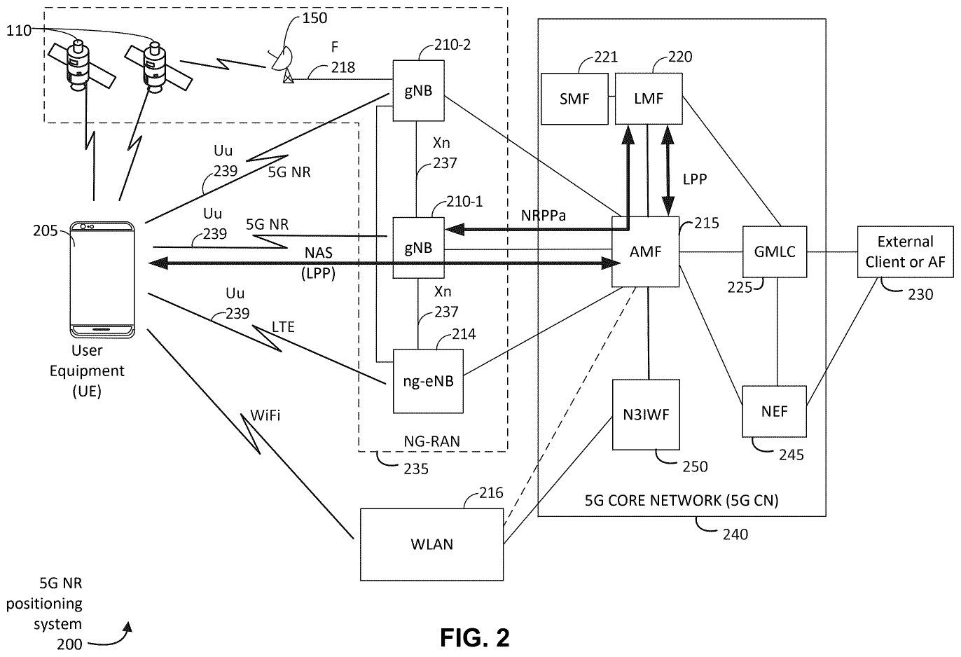

FIG. 1 is a simplified illustration of a positioning system 100, which may be implemented in conjunction with and/or as part of a wireless communication system (e.g., a cellular communication network) which a mobile device 105, location server 160, and/or other components of the positioning system 100 can use the techniques provided herein for providing interference management techniques, according to an embodiment. The techniques described herein may be implemented by one or more components of the positioning system 100, however, the techniques described herein are not limited to such components and may be implemented in other types of systems (not shown). The positioning system 100 can include a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location server 160; network 170; and external client 180. Generally put, the positioning system 100 can estimate the location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation (and sensing) techniques are discussed with regard to FIG. 2.

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. Although illustrated as a mobile phone, the mobile device 105 may comprise any of a variety of devices, including mobile computers (e.g., tablets, laptops, etc.), wearable devices, virtual reality (VR) and/or augmented reality (AR) devices, vehicles (e.g., consumer/industrial/commercial vehicles, aerial vehicles, nautical vehicles, etc., including electronics incorporated into and/or in communication with such vehicles), or the like. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally, or alternatively, because APs 130 also may be communicatively coupled with the network 170, mobile device 105 may communicate with network-connected and Internet-connected devices, including location server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally, or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., satellites 110, APs 130, base stations 120). As explained in more detail below, measurements can include measurements of RF signals exchanged between the mobile device 105 and one or more other mobile devices 145. The estimated location of the mobile device 105 can be estimated geometrically (e.g., using multiangulation and/or multilateration), based on the distance (range) and/or angle measurements, along with known position of the one or more components.

Additionally, or alternatively, the location server 160, may function as a sensing server. A sensing server can be used to coordinate and/or assist in the coordination of sensing of one or more objects (also referred to herein as “targets”) by one or more wireless devices in the positioning system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSS)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, 3GPP and/or other cellular RF signals, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally, or alternatively, the external client 180 may obtain and provide the location of mobile device 105 to an emergency services provider, government agency, etc.

As previously noted, the example positioning system 100 can be implemented using a wireless communication network, such as an LTE-based or 5G NR-based network, or a future 6G network. FIG. 2 shows a diagram of a 5G NR positioning system 200, illustrating an embodiment of a positioning/sensing system (e.g., positioning system 100) implemented in 5G NR. The 5G NR positioning system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 205 by using an LMF 220 (which may correspond with location server 160) to implement the one or more positioning methods. The SMF 221 may coordinate RF sensing by the 5G NR positioning system 200. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning system 200 are described below. The 5G NR positioning system 200 may include additional or alternative components.

The 5G NR positioning system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally, or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (ELTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally, or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally, or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

The principles described above with respect to positioning may be generally extended to RF sensing. That is, RF sensing may be UE-based (e.g., originated from the UE) and/or UE assisted (e.g., originated from a non-UE entity), and may involve UL signals, DL signals, or both (or SL signals in addition or as an alternative to UL and/or DL signals, as noted above). However, RF sensing may differ from positioning in various ways. For example, as previously noted and described in more detail below, RF sensing may involve the use of specific RF sensing signals. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof).

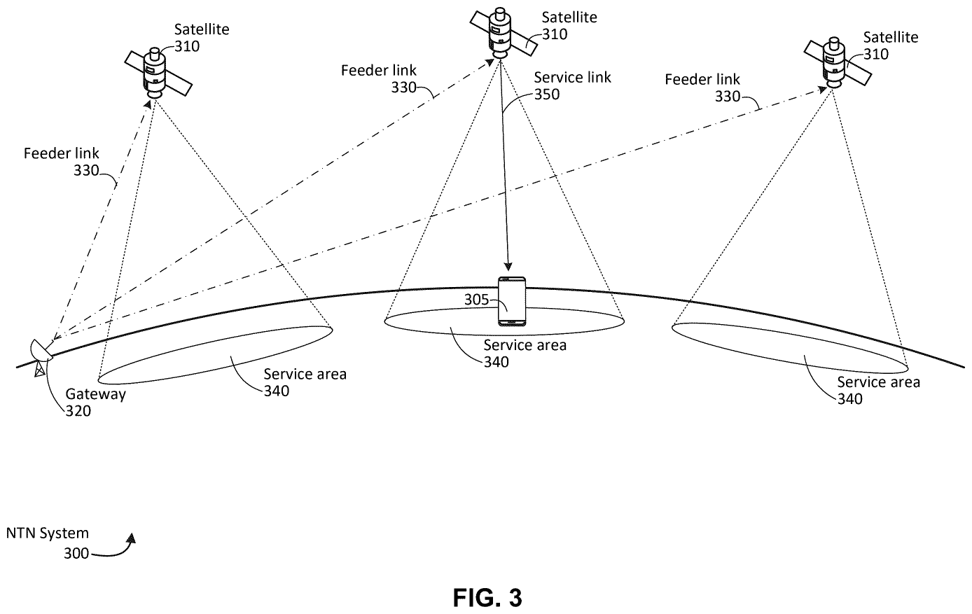

FIG. 3 is a graph illustrating aspects of an NTN system 300, which may be utilized to communicate data and/or provide positioning of a UE 305 (which may correspond to the mobile device 105 of FIG. 1 and/or UE 205 of FIG. 2), and may be part of a larger communication and/or positioning system (e.g., as previously described with respect to FIGS. 1 and/or 2). It can be noted that, although the NTN system 300 illustrated in FIG. 3 illustrates satellites 310 for enabling communications and/or positioning of the UE 305, embodiments are not so limited. An NTN system 300 may additionally or alternatively include other non-terrestrial vehicles (not shown in FIG. 3), including non-space vehicles such as high-altitude platform stations, balloons, airplanes, drones, etc.

The use of satellites 310 and/or other non-terrestrial vehicles to relay communication signals and/or provide positioning for a UE 305 can help provide availability and continuity in geographical regions that may not otherwise be easily serviceable using terrestrial-only means. As noted, satellites 310 may include low earth orbit (LEO) satellites, medium earth orbit (MEO) satellites, and/or geostationary earth orbit (GEO) satellites. The satellites 310 (and/or other non-terrestrial vehicles in an NTN system 300) may connect with a 5G or other communication network via a gateway 320 (which may correspond with gateways 150 in FIGS. 1 and 2) or ground station using wireless RF feeder links 330. Satellites 310 may service corresponding service areas 340, or coverage areas, (which may be divided into one or more subregions, or “beams”), and may establish a service link 350 with a UE within a corresponding service area 340. The service area 340 may move, corresponding with the movement of the respective satellite 310 along its orbit. The service link 350 may serve as a Uu interface to the wireless network access to via the gateway 320. In some embodiments, the gateway 320 and/or satellites 310 may be associated with a base station of cellular network (e.g., gNB of a 5G network), and may comprise remote RUs and/or DUs of the base station, operatively functioning as TRPs, TPs, and/or RPs of the base station.

Positioning a UE 305 using an NTN system 300 may be similar to positioning in a cellular network (e.g., as previously described with regard to 5G NR positioning system 200 of FIG. 2). This can include, for example, the use of satellites 310 and/or other non-terrestrial vehicles of the NTN system 300 as transmission and/or reception points for transmitting and/or receiving reference signals for positioning the UE 305. Reference signals may then be used to perform positioning-related measurements, such as AoA, RTT, TDOA, etc., as previously described. A location server communicatively linked with the gateway 320 may be used to coordinate positioning sessions using the UE 305 and one or more of the satellites 310. If the UE 305 includes a GNSS receiver and is capable of GNSS positioning, such GNSS positioning may be used in addition or as an alternative to network-based positioning using RF signals from NTN and/or terrestrial network (TN) nodes.

Communication via satellite NTN nodes is currently limited to a small portion of the bands within the range of frequencies known as Frequency Range 1 (FR1), which is used in mobile communication networks, such as 5G cellular networks. In particular, NTN satellite bands n255 and n256 are currently the only frequency bands in use. Details regarding these bands are provided in Table 1.

TABLE 1
NTN Satellite Bands

| NTN Satellite Band | Uplink | Downlink |
|---|---|---|
| n255 | 1626.5 MHz-1660.5 MHz | 1525 MHz-1559 MHz |
| n256 | 1980 MHz-2010 MHz | 2170 MHz-2200 MHz |

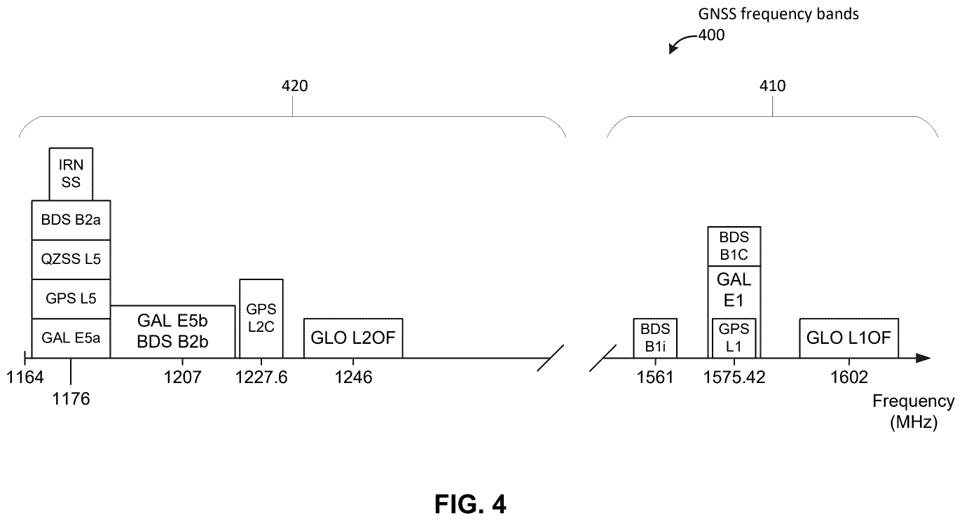

As can be seen in Table 1, the n255 and n256 frequency bands are frequency division duplex (FDD) bands having uplink and downlink frequency ranges shown in the table. Problematically, however, the n255 frequency band (the downlink the range in particular) overlaps with the GNSS L1 band. Details regarding GNSS bands are provided in FIG. 4, discussed below.

FIG. 4 is a diagram of GNSS frequency bands 400, which may be used in GNSS receivers including UEs and other wireless devices, according to embodiments herein. (Like other figures, FIG. 4 not shown to scale). The GNSS frequency bands 400 show that GNSS constellations operate on several frequencies in the L-Band. The L1 frequency band typically covers frequencies from 1559 MHz to 1606 MHz and includes L1 signals from GPS, Galileo, BDS, GLONASS, and QZSS GNSS constellations, such as Galileo E1 Band from 1559 MHz to 1591 MHz with a center frequency of 1575.42 MHz and BDS-BIC centered at 1575.42 MHz with a bandwidth of 32.736 MHz. These bands are referred to generally herein as the “GNSS L1 band.” Bands within this spectrum may be referred to herein as the “upper bands” 410. The same constellations that use these upper bands 410 may also transmit concurrently using one or more other bands in the frequency spectrum generally from 1164 MHz to 1246 MHz, which may be referred to herein as the “lower bands” 420. Example bands within the lower bands 420 include the L2 frequency band and the L5 frequency band. GNSS satellites may transmit, for example, L2 and/or L5 signals along with L1 signals.

As noted, in view of the potential jamming of GNSS L1 band at a UE through the use of RF signals in the NTN n255 band, embodiments can provide interference mitigation techniques. This can involve, among other things, reporting by the UE of such jamming or other conditions. For example, according to some embodiments, the UE can send a report to a location server indicating the capabilities of the UE to perform interference mitigation operations to reduce or avoid interference in the GNSS L1 band from NTN n255 signals. This capability information can include, for example, an ability of the UE to deactivate or turn off hardware that performs positioning based on the GNSS L1 band, a low priority indication for the use of GNSS L1, perform GNSS positioning using alternative bands, and the ability of the UE to perform one or more types of non-GNSS-based positioning, or the like. Additionally, or alternatively, the UE can report actual jamming situations (e.g., the use of the GNSS L1 band while communicating via the NTN n255 band).

Reporting jamming information (e.g., the use of the NTN n255 band) together with GNSS capability information can be useful, regardless of whether the UE is capable of performing GNSS positioning using bands in addition to the GNSS L1 band. For example, in the case in which a UE is unable to perform GNSS positioning without using the L1 band (e.g., low-cost and time division multiplexing (TDM)-based UEs) the UE may indicate this to a location server, along with status information that can convey whether the UE is “camped on” NTN n255 node (e.g., communicates with the serving access node via the NTN n255 band). If this is the case, the location server can determine that jamming is taking place, and instructed UE to perform non-GNSS-based positioning. This can include, for example, device-based hybrid (DBH) positioning, positioning using LPP extensions (LPPe), positioning using cellular-based positioning methods (e.g., OTDOA, ECID, AOA, RTT, etc.), etc., or any combination thereof. GNSS-based methods can be turned off, which can save the UE power. Alternatively, if the UE is capable of performing GNSS-based positioning using alternative GNSS bands to the L1 band, the location server can instruct the UE to switch to one or more alternative bands (e.g., GPS L5 and/or L2), and may provide assistance data relevant to the one or more alternative bands. If the UE is capable of turning off GNSS L1 hardware, it can do so to save power.

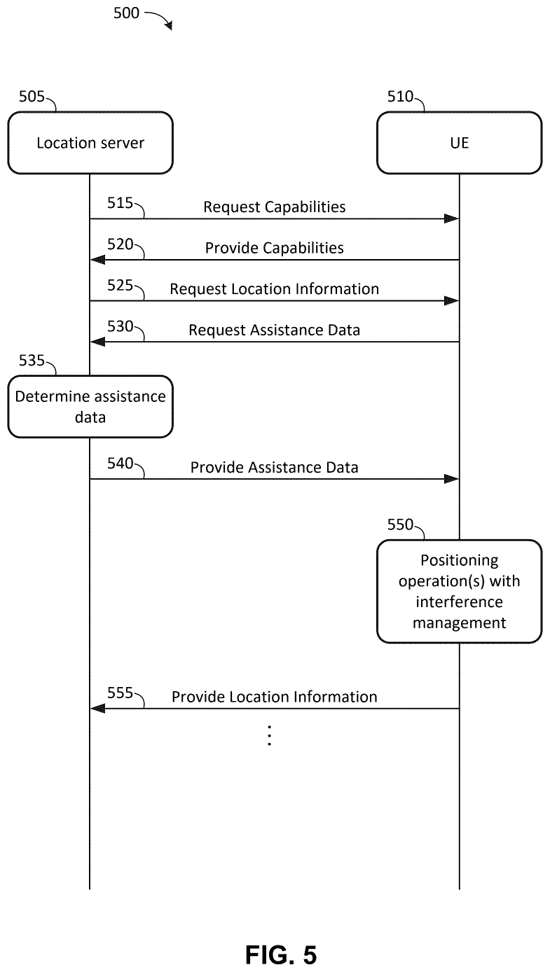

FIG. 5 is a message flow diagram 500 of how embodiments may implement the functionality above in the context of LPP signaling. As previously noted, some embodiments may leverage LPP signaling between a location server 505 and UE 510 to communicate capability information, assistance data, and/or other information described in the embodiments herein. It can be noted that the example illustrated in FIG. 5 is nonlimiting, and alternative embodiments may use additional or alternative LPP exchanges between a UE 510 and the location server 505. The location server 505 may correspond with the location server as described above, such as in relation to FIG. 1 (e.g., location server 160) and FIG. 2 (e.g., LMF 220). The operations in the message flow diagram 500 may be part of a positioning session between the location server 505 and UE 510. Communications (shown by arrows) between location server 505 and UE 510 may be relayed via various devices (e.g., a base station or gNB, as indicated in FIG. 2). To be clear, the messages shown in FIG. 5 may comprise messages as defined by LPP (e.g., LPP Request Capabilities, LPP Provide Capabilities, etc.).

The location server 505 may begin the process illustrated in FIG. 5 with the operation illustrated by arrow 515, in which the location server 505 sends a Request Capabilities message to the UE 510, and the UE 510 may respond with a Provide Capabilities message, as indicated by arrow 520. Generally put, these messages may be communicated in accordance with relevant LPP standards, and may further include information traditionally included in such messages. However, according to some embodiments, the UE 510 may include additional information in the Provide Capabilities message (at arrow 520) to enable the interference management techniques described herein. For example, according to some embodiments, the Provide Capabilities message may include the capability of the UE 505 with respect to what GNSS signals the UE 505 is capable of using for positioning, an indication of whether the GNSS L1 band is being used (which may further specify the particular constellation and band (e.g., GPS L1, GAL E1, BDS BIC), as described above with respect to FIG. 4), a priority level (e.g., low priority indication) of the GNSS L1 band, whether a jamming/interference situation is occurring or expected to occur during positioning (e.g., whether the NTN n255 band is being used by the UE), or the like. According to some embodiments, one or more new information elements (IEs) may be designated within LPP messaging to convey information that may not be included in traditional LPP messaging (e.g., jamming/interference information).

Pursuant to LPP, the process in FIG. 5 may continue with the location server 505 sending a Request Location Information message to the UE 510, as shown by arrow 525. To provide the location information, the UE 510 may then send a Request Assistance Data message to the location server 505, as indicated by arrow 530. This can cause the location server 505 to determine the assistance data, as indicated by block 535.

As previously noted, the location server 505 may determine specific assistance data to implement an interference management technique as described herein, based at least in part on the capabilities of the UE 510, as indicated in the Provide Capabilities message communicated at arrow 520. As described in more detail below, according to some embodiments, the location server 505 can use knowledge of the UEs capabilities, along with information regarding the NTN node with which the UE 510 is in communication and/or information regarding the service area of one or more TN nodes within a threshold distance of the approximate location of the UE 510, to determine the assistance data for the UE 510. This assistance data may be provided to the UE 510 in a Provide Assistance Data message, as indicated at block 540.

At block 550, UE 510 may then perform one or more positioning operations implementing one or more interference management techniques in accordance with the assistance data received from the location server 505. As noted previously, this may include performing one or more non-GNSS-based positioning operations (e.g., performing cellular-based positioning) and/or performing GNSS-based positioning without using the GNSS L1 band (e.g., using one or more alternative GNSS bands). Additionally, or alternatively, as described in more detail below, the UE 510 may perform interference management by retuning its communications so that it is camped on the NTN node using a different frequency band (e.g., NTN n256), or camped on a TN node using a different frequency band. Once the positioning operation(s) is/are performed, the UE 510 may then send to the location server 505 a Provided Location Information message, as indicated at arrow 555.

Again, embodiments are not limited to the LPP exchange shown in FIG. 5. Alternative LPP exchanges may be performed, including exchanges in which the UE 510 determines its own location, for example. Further, some embodiments may allow for a UE 510 to determine its own interference management, which may or may not be based on information received from the location server 505. In such embodiments, a UE may, for example, automatically disable the use of GNSS L1 band when performing GNSS-based positioning while camped on an NTN node using the NTN n255 band, use non-GNSS-based positioning, connect with the wireless communication network via a band other than the NTN n255 band, or the like, for the duration of the positioning operation.

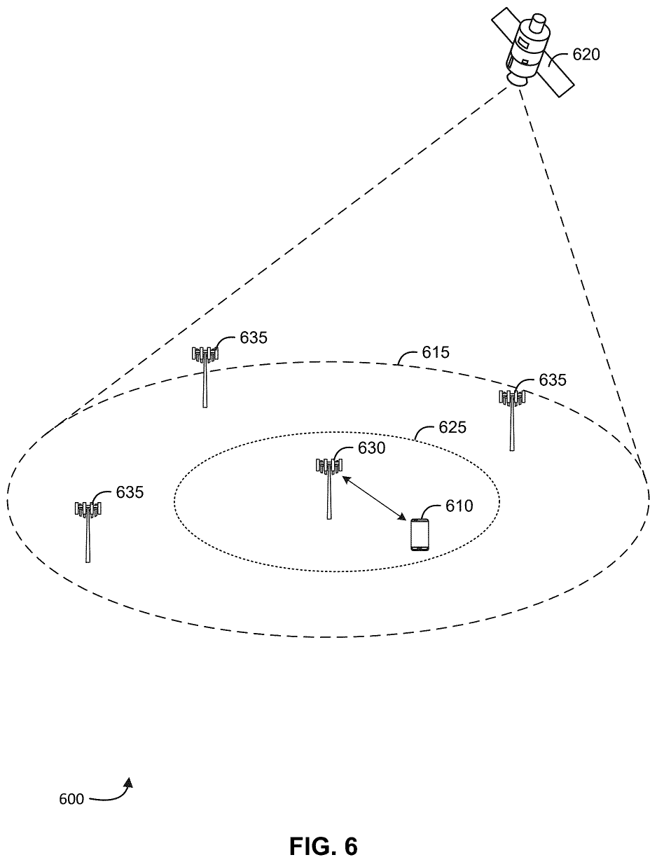

As noted above, according to some embodiments, the location server can acquire and maintain information (e.g., in a database) with band details for NTN nodes (e.g., NTN satellites). This can allow the location server to more fully understand various options available to a UE when an interference/jamming situation arises and instruct the UE accordingly (e.g., via positioning assistance data, as described above). An example situation is illustrated in FIG. 6, described below.

FIG. 6 is an illustration of an example scenario 600 provided to help illustrate potential options for interference management, according to some embodiments. Here, a UE 610 located within an NTN node service area 615 of an NTN node 620 and a TN node service area 625 a TN node 630. Further, nearby (neighboring) TN nodes 635 may be capable of sending and/or receiving signals to/from the UE 610 for positioning purposes.

In this example, the UE 610 may be camped on (serviced by) the NTN node 620 for access to a mobile communication network. If the UE 610 uses the NTN n255 band to communicate with the NTN node 620, the UE 610 may communicate this to a location server, which can then determine options for interference management. As described in more detail below, according to some embodiments, the location server can determine these options based at least in part on information it may gather and maintain from the NTN node 620 and/or other NG-RAN nodes. This information may include, for example, NTN band details regarding the NTN node 620, such as whether the NTN node 620 uses the NTN n255 and/or n256 bands. According to some embodiments, the location server may collect various types of network information to determine options for interference management, in light of the additional information provided by the UE 610 (e.g., using capability information as described in the embodiments above).

The network information collected by the location server can vary, depending on desired functionality. For example, according to some embodiments, the network information may include information regarding timing and/or service area details to know how long the UE 610 may be located within the NTN node service area 615 and which NTN node(s) the UE 610 may be serviced by subsequently, given the course location of the UE 610. Additionally or alternatively, the information may include information regarding which public land mobile networks (PLMNs) and/or network operators operate the various TN and NTN nodes, and whether there may be an agreement (e.g., a “RAN sharing” agreement) between operators of a first group of NTN nodes and operators of TN nodes and/or a second group of NTN nodes that may allow users to connect with both.

To gather this information, the location server may communicate with one or more RAN nodes. For example, a location server may communicate with the one or more RAN nodes (e.g., NTN nodes) via NRPPa protocol to obtain band details and cell information for the nodes. Using this information, the location server can build a database of various NTN nodes (e.g., NTN node 620 and others) with respect to different network operators, which may include information such as the NTN bands used, movement/coverage information, working mode (e.g., store-and-forward mode, or default), and/or other such parameters related to the NTN nodes. Once the location server builds this database, it knows which NTN nodes work on which bands, it can categorize NTN satellite bands accordingly to manage UEs for positioning operations and may take into account NTN node movement when instructing the UE to perform future positioning operations. Again, this can help the location server to refine assistance data provided to a UE to perform interference management as described herein. It may also be beneficial from a ran sharing and network energy saving (NEF) mode, as well as situations such as those illustrated in FIG. 6.

Returning to the example illustrated in FIG. 6, a location server may have many different options for interference management, depending on the functionality of the UE 610, TN nodes 630, 635, and NTN node 620. For example, if the NTN node 620 is capable of communicating in the NTN n256 band the location server may instruct the UE 610 to connect with the NTN node 620 using the NTN n256 band. Alternatively, if, due to the movement of the NTN node 620, the UE will soon be in the NTN node service area of a different NTN node that communicates using the NTN n256 band, the location server may instruct the UE 610 to weights to perform a positioning operation until it is in the NTN node service area of the different NTN node. In some instances, as noted above, the location server may instruct the UE 610 to perform GNSS positioning using bands other than the GNSS L1 band, such as L2 and/or L5. Additionally, or alternatively, the location server may instruct the UE 610 to perform one or more non-GNSS-based positioning operations using, for example, RF signals transmitted to and/or received from the various TN nodes 630, 635. If RAN access is available via TN node 630 or another NTN node (not shown) using a frequency band that does not interfere with the GNSS L1 band), the location server may instruct the UE 610 to connect with the network using the TN node 630 or other NTN node. Again, these options may be determined by location server based on a knowledge of a coarse location of the UE 610, which may be determined based on a positioning history, information regarding the NTN node service area 615, the TN node service area 625, and/or other positioning information (e.g., from sensor data, user input, other network information, etc.). It can be noted that the list of options in this paragraph is not meant to be exhaustive, and alternative embodiments may employ yet other options for interference management that may be available given the circumstances.

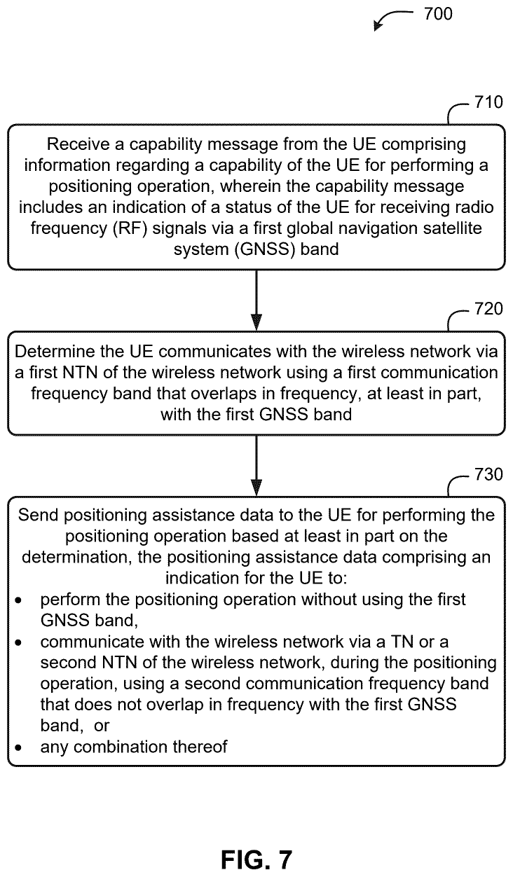

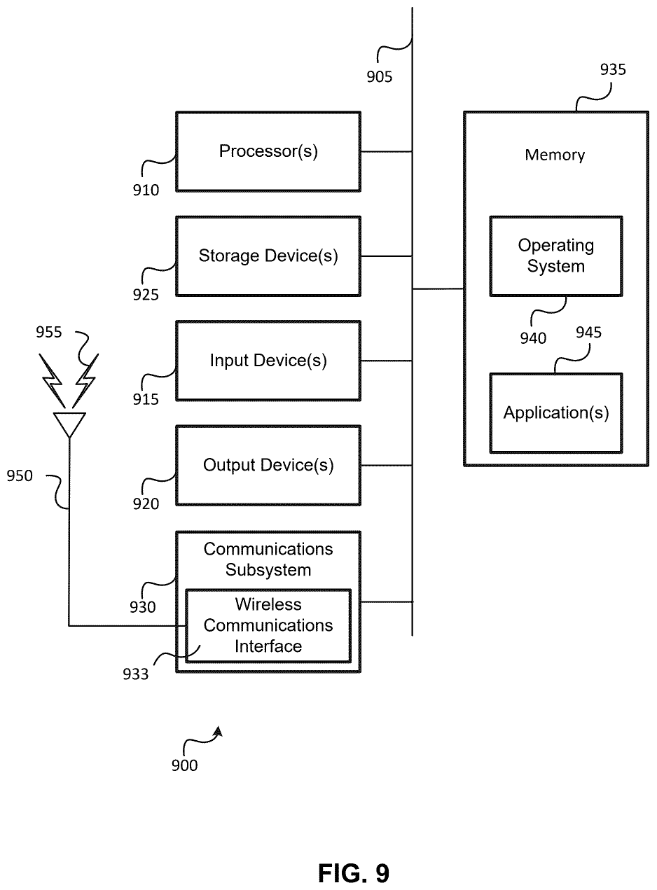

FIG. 7 is a flow diagram of a method 700 of a wireless network for supporting positioning of a UE, according to some embodiments. The method may be performed, for example, by a location server, as described in the embodiments above. As noted in the disclosure above with regard to FIG. 2, for example, this may comprise an LMF to 20 in a 5G NR network. Means and/or structure for performing the functionality of one or more blocks of the method 700 may comprise software and/or hardware components of a computer system. An example computer system is provided in FIG. 9, which is discussed in more detail below.

FIG. 7 is a flow diagram of a method 700 for supporting the positioning of a UE, according to some embodiments. The method may be performed, for example, by a location server as described in the embodiments discussed previously (e.g., location server 160 of FIG. 1, LMF 220 of FIG. 2, and location server 505 of FIG. 5), which may be executed by a computer system. Thus, some or all of the operations shown in the blocks of FIG. 7 may be performed by software and/or hardware components of a computer system, such as the computer system 900 of FIG. 9, described below.

The functionality at block 710 comprises receiving a capability message from the UE comprising information regarding a capability of the UE for performing a positioning operation, wherein the capability message includes an indication of a status of the UE for receiving radio frequency (RF) signals via a first global navigation satellite system (GNSS) band. According to some embodiments, the capability message may comprise a Long-Term Evolution (LTE) Positioning Protocol (LPP) Provide Capabilities message. This capability message may include the capability information in the embodiments described above, such as an ability of the UE to deactivate or turn off hardware that performs positioning based on the first GNSS band, a low priority indication for the use of first GNSS band, an ability to perform GNSS positioning using alternative bands, an ability of the UE to perform one or more types of non-GNSS-based positioning, or the like. As also noted, this information may include a report of actual jamming situations (e.g., the use of the GNSS L1 band while communicating via the NTN n255 band). According to some embodiments, the status of the UE for receiving RF signals via the GNSS band may comprise an indication that: use of the GNSS band by a GNSS receiver of the UE has been deactivated or turned off, a GNSS receiver of the UE has detected a jamming signal on the GNSS band, or any combination thereof.

Means and/or structure for performing functionality at block 710 may comprise a bus 905, one or more processors 910, the communications subsystem 930, at least one memory 935, an operating system 940, one or more applications 945, and/or other components of a computer system 900, as illustrated in FIG. 9 and described below.

The functionality at block 720 comprises determining the UE communicates with the wireless network via a first non-terrestrial-network (NTN) node of the wireless network using a first communication frequency band that overlaps in frequency, at least in part, with the first GNSS band. As previously noted, this may be based on information obtained by the location server, such as which frequency band(s) the first NTN node operates on. As noted in the embodiments above, according to some embodiments, the location server may maintain a database to store information regarding NTN nodes. As noted in the example provided herein, according to some embodiments the first GNSS band may comprise the GNSS L1 band, the first communication frequency band comprises the Frequency Range 1 (FR1) n255 band, or any combination thereof. Again, alternative embodiments may include alternative GNSS bands and/or communication frequency bands.

Means and/or structure for performing functionality at block 720 may comprise a bus 905, one or more processors 910, the communications subsystem 930, at least one memory 935, an operating system 940, one or more applications 945, and/or other components of a computer system 900, as illustrated in FIG. 9 and described below.

The functionality at block 730 sending positioning assistance data to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network, during the positioning operation, using a second communication frequency band that does not overlap in frequency with the first GNSS band, or any combination thereof. As noted in the embodiments described above, the positioning assistance data may instruct the UE how to proceed with the positioning operation in view of the various circumstances. For example, according to some embodiments, the positioning assistance data may comprise the indication for the UE to indication for the UE to perform the positioning operation without using the first GNSS band, where the indication for the UE to perform the positioning operation without using the first GNSS band comprises an indication of: one or more alternative GNSS bands to use for performing the positioning operation, one or more non-GNSS positioning methods to use for performing the positioning operation, or any combination thereof. Additionally, or alternatively, the positioning assistance data may comprise the indication for the UE to communicate with the wireless network via the TN node using the second communication frequency band, where the method further comprises identifying the TN node based, at least in part, on data regarding the first NTN node received by the location server from one or more radio access network (RAN) nodes of the wireless network. As noted in the embodiments above (e.g., with respect to FIG. 6), such embodiments may include one or more additional features, depending on desired functionality. For example, according to some embodiments, determining the UE communicates with the wireless network via the first NTN node using the first communication frequency may be based, at least in part, on the data regarding the NTN. This may include, for example, information regarding the frequency band(s) with which the first NTN node communicates. According to some embodiments, the first NTN node may be operated by a first wireless network operator, and the TN node may be operated by a second wireless network operator. Thus, as noted herein, the location server may be aware of the range sharing agreement between operators and may convey information to the UE via the positioning assistance data based on this information. Additionally or alternatively, according to some embodiments, the positioning assistance data may comprise the indication for the UE to communicate with the wireless network via the second NTN node, and wherein the first NTN node is operated by a first wireless network operator, and the second NTN node is operated by a second wireless network operator. According to some embodiments, the data regarding the NTN received by the location server from the one or more RAN nodes is received via one or more New Radio (NR) Positioning Protocol A (NRPPa) messages.

Means and/or structure for performing functionality at block 730 may comprise a bus 905, one or more processors 910, the communications subsystem 930, at least one memory 935, an operating system 940, one or more applications 945, and/or other components of a computer system 900, as illustrated in FIG. 9 and described below.

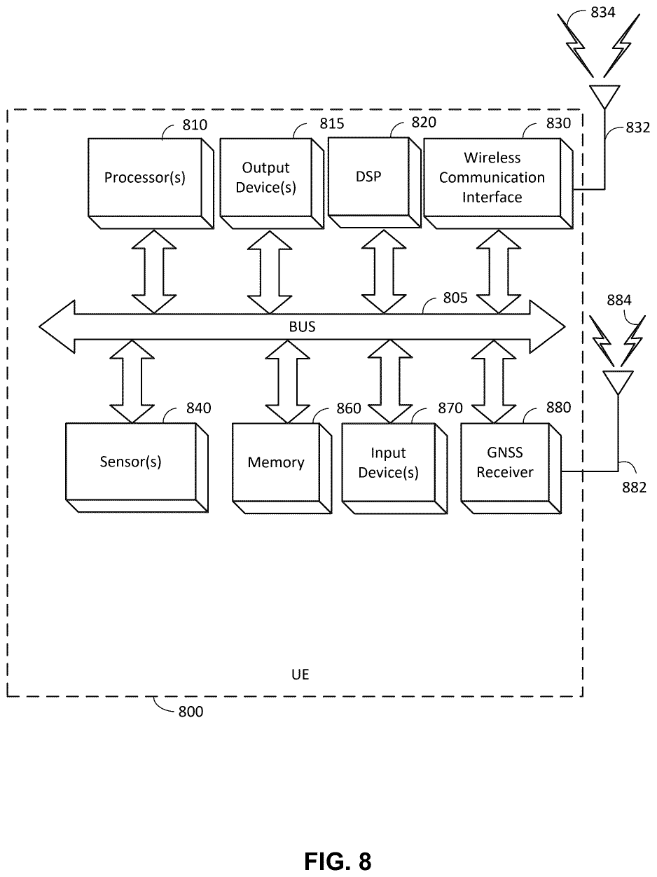

FIG. 8 is a block diagram of an embodiment of a GNSS-capable UE 800, which can be utilized as described herein above (e.g., in association with FIGS. 1-8). It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, the UE 800 may be incorporated into another device, such as a cell phone, vehicle, etc., as previously noted.

The UE 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 800 to communicate with other devices as described in the embodiments above. The wireless communication interface 830 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The UE 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 800 (and/or processor(s) 810 or DSP 820 within UE 800). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of various devices described herein, including a server (e.g., location server/LMF), base station, TN node, NTN node, or a combination thereof. It should be noted that FIG. 9 is meant only to provide a generalized illustration of various components, any or all of which may be utilized as appropriate. Further, computer system 900 may be capable of performing some or all of the functions of method 700 of FIG. 7. FIG. 9 broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network and/or any other electronic devices described herein. Hence, the communications subsystem 930 may be used to receive and send data as described in the embodiments herein. In some embodiments, the computer system 900 may comprise a GNSS receiver, which may be a discrete component (not shown) and/or may be integrated into another component of the computer system 900.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally, or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method at a location server of a wireless network for supporting positioning of a user equipment (UE), the method comprising: receiving a capability message from the UE comprising information regarding a capability of the UE for performing a positioning operation, wherein the capability message includes an indication of a status of the UE for receiving radio frequency (RF) signals via a first global navigation satellite system (GNSS) band; determining the UE communicates with the wireless network via a first non-terrestrial-network (NTN) node of the wireless network using a first communication frequency band that overlaps in frequency, at least in part, with the first GNSS band; and sending positioning assistance data to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

Clause 2: The method of clause 1, wherein the positioning assistance data comprises the indication for the UE to perform the positioning operation without using the first GNSS band, and wherein the indication for the UE to perform the positioning operation without using the first GNSS band comprises an indication of: one or more alternative GNSS bands to use for performing the positioning operation, one or more non-GNSS positioning methods to use for performing the positioning operation, or any combination thereof.

Clause 3: The method of either of clauses 1 or 2, wherein the positioning assistance data comprises the indication for the UE to communicate with the wireless network via the TN node using the second communication frequency band, and wherein the method further comprises identifying the TN node based, at least in part, on data regarding the first NTN node received by the location server from one or more radio access network (RAN) nodes of the wireless network.

Clause 4: The method of clause 3, wherein determining the UE communicates with the wireless network via the first NTN node using the first communication frequency is based, at least in part, on the data regarding the NTN.

Clause 5: The method of any one of clauses 3-4, wherein the first NTN node is operated by a first wireless network operator, and the TN node is operated by a second wireless network operator.

Clause 6: The method of any one of clauses 3-5, wherein the data regarding the NTN received by the location server from the one or more RAN nodes is received via one or more New Radio (NR) Positioning Protocol A (NRPPa) messages.

Clause 7: The method of any one of clauses 1-6, wherein the positioning assistance data comprises the indication for the UE to communicate with the wireless network via the second NTN node, and wherein the first NTN node is operated by a first wireless network operator, and the second NTN node is operated by a second wireless network operator.

Clause 8: The method of any one of clauses 1-7, wherein: the first GNSS band comprises a GNSS L1 band, the first communication frequency band comprises the Frequency Range 1 (FR1) n255 band, or any combination thereof.

Clause 9: The method of any one of clauses 1-8, wherein the status of the UE for receiving RF signals via the GNSS band comprises an indication that: use of the GNSS band by a GNSS receiver of the UE has been deactivated or turned off, a GNSS receiver of the UE has detected a jamming signal on the GNSS band, or any combination thereof.

Clause 10: The method of any one of clauses 1-9, wherein the capability message comprises a Long-Term Evolution (LTE) Positioning Protocol (LPP) Provide Capabilities message.

Clause 11: A location server comprising: one or more transceivers; one or more memories; and one or more processors communicatively coupled with the one or more transceivers and the one or more memories, the one or more processors configured to: receive a capability message, via the one or more transceivers, from a user equipment (UE) comprising information regarding a capability of the UE for performing a positioning operation, wherein the capability message includes an indication of a status of the UE for receiving radio frequency (RF) signals via a first global navigation satellite system (GNSS) band; determine the UE communicates with a wireless network via a first non-terrestrial-network (NTN) node of the wireless network using a first communication frequency band that overlaps in frequency, at least in part, with the first GNSS band; and send positioning assistance data, via the one or more transceivers, to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

Clause 12: The location server of clause 11, wherein when including the indication for the UE to perform the positioning operation without using the first GNSS band in the positioning assistance data, the one or more processors are configured to include, in the indication for the UE to perform the positioning operation without using the first GNSS band, an indication of: one or more alternative GNSS bands to use for performing the positioning operation, one or more non-GNSS positioning location servers to use for performing the positioning operation, or any combination thereof.

Clause 13: The location server of either of clauses 11 or 12, wherein when including the indication for the UE communicate with the wireless network via the TN node using the second communication frequency band in the positioning assistance data, the one or more processors are configured to identify the TN node based, at least in part, on data regarding the first NTN node received by the location server from one or more radio access network (RAN) nodes of the wireless network.

Clause 14: The location server of clause 13, wherein the one or more processors are configured to determine the UE communicates with the wireless network via the first NTN node using the first communication frequency based, at least in part, on the data regarding the NTN.

Clause 15: The location server of any one of clauses 13-14, wherein the one or more processors are configured to receive the data regarding the NTN from the one or more RAN nodes via one or more New Radio (NR) Positioning Protocol A (NRPPa) messages.

Clause 16: The location server of any one of clauses 11-15, wherein: the first GNSS band comprises a GNSS L1 band, the first communication frequency band comprises the Frequency Range 1 (FR1) n255 band, or any combination thereof.

Clause 17: The location server of any one of clauses 11-16, wherein the status of the UE for receiving RF signals via the GNSS band comprises an indication that: use of the GNSS band by a GNSS receiver of the UE has been deactivated or turned off, a GNSS receiver of the UE has detected a jamming signal on the GNSS band, or any combination thereof.

Clause 18: The location server of any one of clauses 11-17, wherein, to receive the capability message, the one or more processors are configured to receive a Long-Term Evolution (LTE) Positioning Protocol (LPP) Provide Capabilities message.

Clause 19: A device comprising: means for receiving a capability message from a user equipment (UE) comprising information regarding a capability of the UE for performing a positioning operation, wherein the capability message includes an indication of a status of the UE for receiving radio frequency (RF) signals via a first global navigation satellite system (GNSS) band; means for determining the UE communicates with a wireless network via a first non-terrestrial-network (NTN) node of the wireless network using a first communication frequency band that overlaps in frequency, at least in part, with the first GNSS band; and means for sending positioning assistance data to the UE for performing the positioning operation based at least in part on the determination, the positioning assistance data comprising an indication for the UE to: perform the positioning operation without using the first GNSS band, communicate with the wireless network via a terrestrial node (TN) or a second NTN node of the wireless network during the positioning operation, using a second communication frequency band that does not overlap in frequency with the first GNSS band, or any combination thereof.

Clause 20: The device of clause 19, wherein the positioning assistance data comprises the indication for the UE to perform the positioning operation without using the first GNSS band, and wherein the indication for the UE to perform the positioning operation without using the first GNSS band comprises an indication of: one or more alternative GNSS bands to use for performing the positioning operation, one or more non-GNSS positioning methods to use for performing the positioning operation, or any combination thereof.

What is claimed is:

1. A method at a location server of a wireless network for supporting positioning of a user equipment (UE), the method comprising:
receiving a capability message from the UE comprising information regarding a capability of the UE for performing a positioning operation, wherein the capability message includes an indication of a status of the UE for receiving radio frequency (RF) signals via a first global navigation satellite system (GNSS) band;
determining the UE communicates with the wireless network via a first non-terrestrial-network (NTN) node of the wireless network using a first communication frequency band that overlaps in frequency, at least in part, with the first GNSS band; and
sending positioning assistance data to the UE for performing the positioning operation based at least in part on the determination, the positioning assistance data comprising an indication for the UE to:
perform the positioning operation without using the first GNSS band,
communicate with the wireless network via a terrestrial node (TN) or a second NTN node of the wireless network during the positioning operation, using a second communication frequency band that does not overlap in frequency with the first GNSS band, or
any combination thereof.

2. The method of claim 1, wherein the positioning assistance data comprises the indication for the UE to perform the positioning operation without using the first GNSS band, and wherein the indication for the UE to perform the positioning operation without using the first GNSS band comprises an indication of:
one or more alternative GNSS bands to use for performing the positioning operation,
one or more non-GNSS positioning methods to use for performing the positioning operation, or
any combination thereof.

3. The method of claim 1, wherein the positioning assistance data comprises the indication for the UE to communicate with the wireless network via the TN node using the second communication frequency band, and wherein the method further comprises identifying the TN node based, at least in part, on data regarding the first NTN node received by the location server from one or more radio access network (RAN) nodes of the wireless network.

4. The method of claim 3, wherein determining the UE communicates with the wireless network via the first NTN node using the first communication frequency is based, at least in part, on the data regarding the NTN.

5. The method of claim 3, wherein the first NTN node is operated by a first wireless network operator, and the TN node is operated by a second wireless network operator.

6. The method of claim 3, wherein the data regarding the NTN received by the location server from the one or more RAN nodes is received via one or more New Radio (NR) Positioning Protocol A (NRPPa) messages.

7. The method of claim 1, wherein the positioning assistance data comprises the indication for the UE to communicate with the wireless network via the second NTN node, and wherein the first NTN node is operated by a first wireless network operator, and the second NTN node is operated by a second wireless network operator.

8. The method of claim 1, wherein:
the first GNSS band comprises the GNSS L1 band,
the first communication frequency band comprises the Frequency Range 1 (FR1) n255 band, or
any combination thereof.

9. The method of claim 1, wherein the status of the UE for receiving RF signals via the GNSS band comprises an indication that:
use of the GNSS band by a GNSS receiver of the UE has been deactivated or turned off,
a GNSS receiver of the UE has detected a jamming signal on the GNSS band, or
any combination thereof.

10. The method of claim 1, wherein the capability message comprises a Long-Term Evolution (LTE) Positioning Protocol (LPP) Provide Capabilities message.

11. A location server comprising:
one or more transceivers;
one or more memories; and
one or more processors communicatively coupled with the one or more transceivers and the one or more memories, the one or more processors configured to:
receive a capability message, via the one or more transceivers, from a user equipment (UE) comprising information regarding a capability of the UE for performing a positioning operation, wherein the capability message includes an indication of a status of the UE for receiving radio frequency (RF) signals via a first global navigation satellite system (GNSS) band;
determine the UE communicates with a wireless network via a first non-terrestrial-network (NTN) node of the wireless network using a first communication frequency band that overlaps in frequency, at least in part, with the first GNSS band; and
send positioning assistance data, via the one or more transceivers, to the UE for performing the positioning operation based at least in part on the determination, the positioning assistance data comprising an indication for the UE to:
perform the positioning operation without using the first GNSS band,
communicate with the wireless network via a terrestrial node (TN) or a second NTN node of the wireless network during the positioning operation, using a second communication frequency band that does not overlap in frequency with the first GNSS band, or
any combination thereof.

12. The location server of claim 11, wherein when including the indication for the UE to perform the positioning operation without using the first GNSS band in the positioning assistance data, the one or more processors are configured to include, in the indication for the UE to perform the positioning operation without using the first GNSS band, an indication of:
one or more alternative GNSS bands to use for performing the positioning operation,
one or more non-GNSS positioning location servers to use for performing the positioning operation, or
any combination thereof.

13. The location server of claim 11, wherein when including the indication for the UE communicate with the wireless network via the TN node using the second communication frequency band in the positioning assistance data, the one or more processors are configured to identify the TN node based, at least in part, on data regarding the first NTN node received by the location server from one or more radio access network (RAN) nodes of the wireless network.

14. The location server of claim 13, wherein the one or more processors are configured to determine the UE communicates with the wireless network via the first NTN node using the first communication frequency based, at least in part, on the data regarding the NTN.

15. The location server of claim 13, wherein the one or more processors are configured to receive the data regarding the NTN from the one or more RAN nodes via one or more New Radio (NR) Positioning Protocol A (NRPPa) messages.

16. The location server of claim 11, wherein:
the first GNSS band comprises a GNSS L1 band,
the first communication frequency band comprises the Frequency Range 1 (FR1) n255 band, or
any combination thereof.

17. The location server of claim 11, wherein the status of the UE for receiving RF signals via the GNSS band comprises an indication that:
use of the GNSS band by a GNSS receiver of the UE has been deactivated or turned off,
a GNSS receiver of the UE has detected a jamming signal on the GNSS band, or
any combination thereof.

18. The location server of claim 11, wherein, to receive the capability message, the one or more processors are configured to receive an Long-Term Evolution (LTE) Positioning Protocol (LPP) Provide Capabilities message.

19. A device comprising:
means for receiving a capability message from a user equipment (UE) comprising information regarding a capability of the UE for performing a positioning operation, wherein the capability message includes an indication of a status of the UE for receiving radio frequency (RF) signals via a first global navigation satellite system (GNSS) band;
means for determining the UE communicates with a wireless network via a first non-terrestrial-network (NTN) node of the wireless network using a first communication frequency band that overlaps in frequency, at least in part, with the first GNSS band; and
means for sending positioning assistance data to the UE for performing the positioning operation based at least in part on the determination, the positioning assistance data comprising an indication for the UE to:
perform the positioning operation without using the first GNSS band,
communicate with the wireless network via a terrestrial node (TN) or a second NTN node of the wireless network during the positioning operation, using a second communication frequency band that does not overlap in frequency with the first GNSS band, or
any combination thereof.

20. The device of claim 19, wherein the positioning assistance data comprises the indication for the UE to perform the positioning operation without using the first GNSS band, and wherein the indication for the UE to perform the positioning operation without using the first GNSS band comprises an indication of:
one or more alternative GNSS bands to use for performing the positioning operation,
one or more non-GNSS positioning methods to use for performing the positioning operation, or
any combination thereof.
